(19) United States
(12) Patent Application Publication
(10) Pub. No.: US 2005/0155293 A1
(43) Pub. Date: Jul. 21, 2005

(54) Seals comprising at least one flexible lip designed to be in contact with a sliding window of an automobile

(76) Inventor: Bernard Dron, Puteaux (FR)

Correspondence Address: Stephen B. Salai, Esq.;Harter, Secrest & Emery LLP, 1600 Bausch & Lomb Place, Rochester, NY, 14604-2711, US

(21) Appl. No.: 10/999,038

(22) Filed: Nov. 29, 2004

(30) Foreign Application Priority Data
Nov. 27, 2003 (FR) 03 13922

(51) Int. Cl. E06B 7/16

(52) U.S. Cl. 49/490.1

(57) ABSTRACT

This seal comprises at least one flexible lip (3) designed to be in contact with the sliding window (4) of an automobile via a surface coated with a film (5) of a hard material with a low friction coefficient, characterized in that a layer of a cellular plastomer or cellular elastomer is inserted between the lip and the hard material with a low friction coefficient so as to separate them virtually completely.

This invention relates to seals that include a flexible lip designed to come into contact with a sliding window of an automobile. More specifically, it relates to the improvements made to the lips of such seals in order to reduce the noise that results from the friction created by one or both lips against the window when this window is moved.

These seals, which may be in the form of a sealing strip or a runner or may be built into the door for coupes, convertibles, and cars with frameless doors, have one or several lips in contact with at least one side of the sliding window with which they interact.

In a transversal cross section, the body of the seal usually comprises a portion with a U-shaped transversal section that caps a protruding part of the window frame, and includes one or two lips that are adjacent to a leg of the U shape or to a part adjacent to this portion. The body of the seal is usually made of an elastomer or plastomer such as polypropylene, generally hard or reinforced, whereas the flexible lip or lips are made of a material that is elastically malleable, e.g., an elastomer or plastomer. The body and the lip or lips of the seal are generally produced by co-extrusion.

In order to withstand repeated movements and facilitate the gliding of the window in contact with the lip or lips on the seal, the surface of these lips lapping a surface of the glass is usually covered with a slip coating, but this film is generally very hard and when it comes in contact with the window as the window is moved, irritating noises are produced that are very disagreeable to those inside the car; there may even be repeated impacts if the window is slightly open.

Therefore, we wish to have access to an easily implemented and inexpensive means of eliminating this inconvenience.

This is the problem that this invention intends to resolve.

To this end, the subject of this invention is a seal comprising at least one flexible lip designed to be in contact with the sliding window of an automobile via a surface coated with a film of hard material with a low friction coefficient, said seal being characterized in that a layer of a cellular plastomer or cellular elastomer that is compatible with the hard material with a low friction coefficient, with which this layer is co-extruded, is inserted between the lip and said hard material with a low friction coefficient so as to separate them virtually completely.

The Applicant has determined that the use of a layer of such cellular material considerably reduces the transmission of noises resulting from the vibrations of the lip when the window with which the lip is in contact moves or, if slightly open, vibrates from the effects of the road and the chassis.

In practice, the noise transmitted to the interior of the car is highly attenuated and more muffled than usual, and as a result, it is much less bothersome for the driver and the passengers in the car. Under certain conditions, this noise may even disappear completely.

A leaktight seal has already been proposed in U.S. Pat. No. 6,286,841 B₁, said seal being designed to come into contact with a moving glass sheet and comprising a base 20 made of elastomer and a surface layer 50 that comes into contact with the glass sheet. Between these two sections of the seal, a spongy secondary layer made of an open-cell material is inserted that contains an adhesive 40, but this binding component makes the seal more difficult to produce and reduces its flexibility.

We also know of a seal lip 2 from German Patent 40 35 658 A that includes a surface layer 5 made of polytetrafluoroethylene (a material that does not glide very easily across glass), a layer 3 of an expanded plastic material and a base 1, but as polytetrafluoroethylene is well known for its lack of adherence to most materials, an intermediate layer 6 of an adhesive material must also be inserted between the polytetrafluoroethylene and the expanded plastic material.

The seal in accordance with the invention eliminates these drawbacks.

In this seal, the cellular material used to produce the layer inserted between the lip itself and the slip coating with a low friction coefficient with which it is coated so as not to impede the movement of the window may be a made from an elastomer such as E.P.D.M. [ethylene-propylene terpolymer rubber], or a plastomer, such as T.P.V. (Thermoplastic vulcanizate).

This cellular elastomer or plastomer may be manufactured with the body of the seal and its associated lip, e.g., by co-extrusion with the latter, or manufactured separately with the slip coating and positioned subsequently on the lip, e.g., by means of clipping.

The drawings attached illustrate, by way of example, these two versions of a seal with a flexible lip in accordance with the invention. On these drawings:

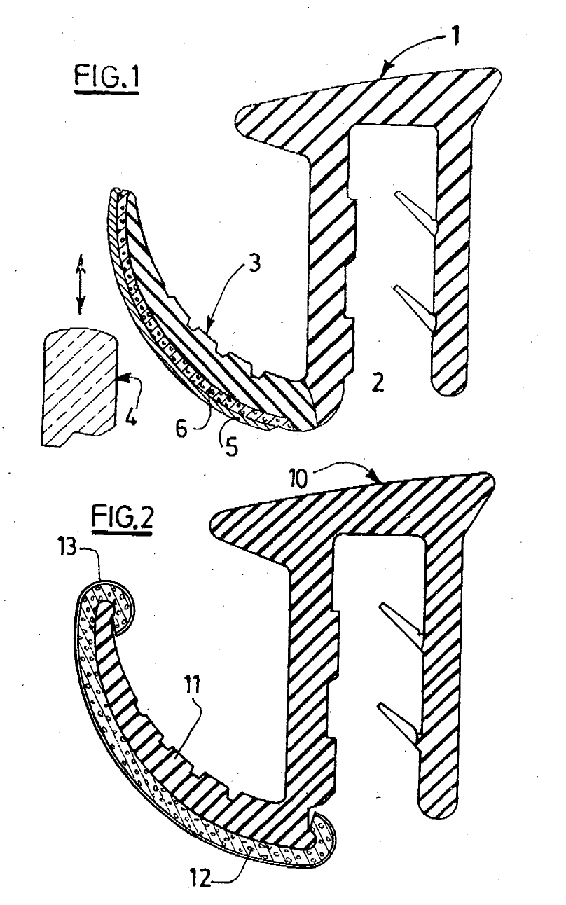

FIG. 1 is a cross-section of a sealing strip produced by co-extrusion of its components;

FIG. 2 is a cross-section of another sealing strip whose components are manufactured separately and assembled by clipping.

The seal represented on FIG. 1 contains a section 1 with a U-shaped transversal section, made of E.P.D.M. with a hardness greater than 90 Shore A, designed to cap a rabbet of a door panel.

One end of a leg 2 of the section 1 is adjacent to a flexible lip 3, made of E.P.D.M. or T.P.V, capable of retracting upon the passage of a sliding window 4 and lapping the side of the window turned toward it.

In order for the window 4 to slide more easily against the lip 3, the latter is usually coated on the surface turned toward the window with a film 5 of a hard varnish with a low friction coefficient, and the impact of this varnish against the window 4, when subjected to the effect of the vibration of the lip 3 or the window when the latter is moved, usually takes the form of disagreeable noises in the interior of the car.

To attenuate this noise and even eliminate it in accordance with the invention, a thin layer 6 of cellular E.P.D.M. or T.P.V. is inserted between the lip 3 and the film 5 so as to separate them completely; this considerably muffles the transmission of sound waves resulting from the friction between the varnish 5 and the window 4.

The film 6 made of cellular E.P.D.M. or T.P.V. (Thermoplastic vulcanizate) is very thin and may be produced by means of co-extrusion with the section 1 and the lip 3, such that the supplementary cost imposed by this film is practically negligible.

The version of the invention shown in FIG. 2 shows a window sealing strip consisting of a section made of E.P.D.M. 10 with a U-shaped section to which is attached a lip 11 made of the same material and co-extruded with the body 10.

To the surface of the lip 11 that faces outwards is added a component 12 made of cellular E.P.D.M., separately manufactured, to which a thin layer 13 of slip coating is attached.

The component 12 is clipped transversally to lip 11 so that they form an integral part.

Naturally, the lips found on a runner in a window frame may be adapted in the same manner as those that we have just described with regard to a sealing strip, with the same advantages.

1. Seal comprising at least one flexible lip (3) designed to be in contact with the sliding window (4) of an automobile via a surface coated with a film (5) of hard material with a low friction coefficient, said seal being characterized in that a layer (6) of a cellular plastomer or cellular elastomer that is compatible with the hard material with a low friction coefficient is inserted between the lip and said hard material with a low friction coefficient so as to separate them virtually completely, and in that the layer (6) and material (5) are co-extruded.

2. Seal according to claim 1, characterized in that the cellular material that makes up the layer (6) of cellular material is an E.P.D.M. or T.P.V.

3. Seal according to claim 1, characterized in that the body (1) of the seal and the lip (3) are co-extruded with the layer (6) made of a cellular plastomer or cellular elastomer and the film (5) made of a hard material with a low friction coefficient.

4. Seal according to claim 2, characterized in that the body (1) of the seal and the lip (3) are co-extruded with the layer (6) made of a cellular plastomer or cellular elastomer and the film (5) made of a hard material with a low friction coefficient.

5. Seal according to claim 1, characterized in that the layer of cellular elastomer or cellular plastomer is produced with the film (13) of hard material with a low friction coefficient that it supports, separately from the body (1) of the seal and the lip (13), in the form of a component (12) that can be transversally clipped onto the lip (13).

6. Seal according to claim 2, characterized in that the layer of cellular plastomer or cellular elastomer is produced with the film (13) of hard material with a low friction coefficient that it supports, separately from the body (10) of the seal and the lip (13), in the form of a component (12) that can be transversally clipped onto the lip (13).

7. Seal according to claim 1, characterized in that it consists of a sealing strip or runner for a sliding window.

8. Seal according to claim 2, characterized in that it consists of a sealing strip or runner for a sliding window.

9. Seal according to claim 3, characterized in that it consists of a sealing strip or runner for a sliding window.

10. Seal according to claim 4, characterized in that it consists of a sealing strip or runner for a sliding window.

11. Seal according to claim 5, characterized in that it consists of a sealing strip or runner for a sliding window.

12. Seal according to claim 6, characterized in that it consists of a sealing strip or runner for a sliding window.
